(19) United States
(12) Patent Application Publication
(10) Pub. No.: US 2016/0005065 A1
(43) Pub. Date: Jan. 7, 2016

(54) VALIDATING MOBILE COUPONS OR VOUCHERS

(71) Applicant: OP-PALVELUT OY, Helsinki (FI)

(72) Inventors: Kristian LUOMA, Helsinki (FI); Tuomas JOMPPANEN, Helsinki (FI); Jussi JUNTUNEN, Helsinki (FI)

(21) Appl. No.: 14/768,574

(22) PCT Filed: Feb. 19, 2014
(86) PCT No.: PCT/FI2014/050123

§ 371 Date: Aug. 18, 2015

(30) Foreign Application Priority Data
Feb. 22, 2013 (FI) 20135163

(51) Int. Cl. G06Q 30/02

(52) U.S. Cl. CPC G06Q 30/0225

(57) ABSTRACT

Apparatus and method are provided. The solution includes in an apparatus controlling (304) a detector to obtain wirelessly from an object external to the apparatus information on an identifier related to a retailer; determining (306) the identification of a retailer on the basis of the identifier; transmitting (308) a query to the network server, the query including the identification of the retailer; receiving (310) a response from the server, the response including information on available retailer related benefits of the user; and if there are available benefits, controlling (312) the communication of the information on the benefits to the user.

### FIELD

The exemplary and non-limiting embodiments of the invention relate generally to electronic coupons or benefits in mobile devices and especially validating the coupons or benefits.

### BACKGROUND

The emerging electronic media and mobile computing offer new possibilities in the communication between a consumer and retailers. Retailers have offered special benefits for loyal customers in form of membership cards or special discounts to all customers in form of coupons in advertisements, for example. Both forms of communication have been introduced in the mobile communication environment as electronic membership cards or electronic coupons or vouchers. A problem associated with these electronic forms of communication is the question of the authenticity of the electronic cards and benefits.

### SUMMARY

The present invention seeks to provide an improved solution for validating electronic cards, vouchers or other forms of benefits.

According to an aspect of the present invention, there is provided an apparatus, comprising: at least one processor; at least one memory including computer program code, and user interface; the at least one memory and the computer program code configured to, with the at least one processor, cause the apparatus at least to perform: control obtaining in a wireless manner information on an identifier related to a retailer from an object external to the apparatus; determine the identification of a retailer on the basis of the identifier; control the transmission of identification related to the user of the apparatus to a network server; control the transmission of a query to the network server, the query comprising the identification of the retailer; control the reception of a response from the server, the response comprising information on available retailer related benefits of the user; and if there are available benefits, control the communication, utilizing the user interface, of the information on the benefits to the user.

According to an aspect of the present invention, there is provided a server comprising a communication interface, a memory interface, and a processor, wherein the processor is configured to cause the server at least to perform: maintain via the memory interface a connection to a database comprising information on users, benefits offered by retailers and which users are eligible for which benefit; receive via the communication interface a query regarding a user and a retailer; determine if the user is eligible for a benefit in the retailer; transmit via the communication interface a response on the basis of the determination.

According to another aspect of the present invention, there is provided a method in an apparatus, comprising: controlling a detector to obtain wirelessly from an object external to the apparatus information on an identifier related to a retailer; determining the identification of a retailer on the basis of the identifier; controlling the transmission of identification related to the user of the apparatus to a network server; controlling the transmission of a query to the network server, the query comprising the identification of the retailer; controlling the reception of a response from the server, the response comprising information on available retailer related benefits of the user; and if there are available benefits, controlling the communication of the information on the benefits to the user.

According to another aspect of the present invention, there is provided a method in an apparatus, comprising: maintaining a database comprising information on users, benefits offered by retailers and which users are eligible for which benefit; receiving a query regarding a user and a retailer; determining if the user is eligible for a benefit in the retailer; transmitting a response on the basis of the determination.

### LIST OF DRAWINGS

Embodiments of the present invention are described below, by way of example only, with reference to the accompanying drawings, in which

FIG. 1 illustrates an example of a general operating environment applicable to some embodiments of the invention;

FIG. 2 illustrates an example of authentication;

FIG. 3 is a flowchart illustrating an embodiment of the invention;

FIG. 4 illustrates an example of an apparatus in which some embodiments of the invention may be applied;

FIG. 5 is a flowchart illustrating an embodiment of the invention; and

FIG. 6 illustrates an example of an apparatus in which some embodiments of the invention may be applied.

### DESCRIPTION OF SOME EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

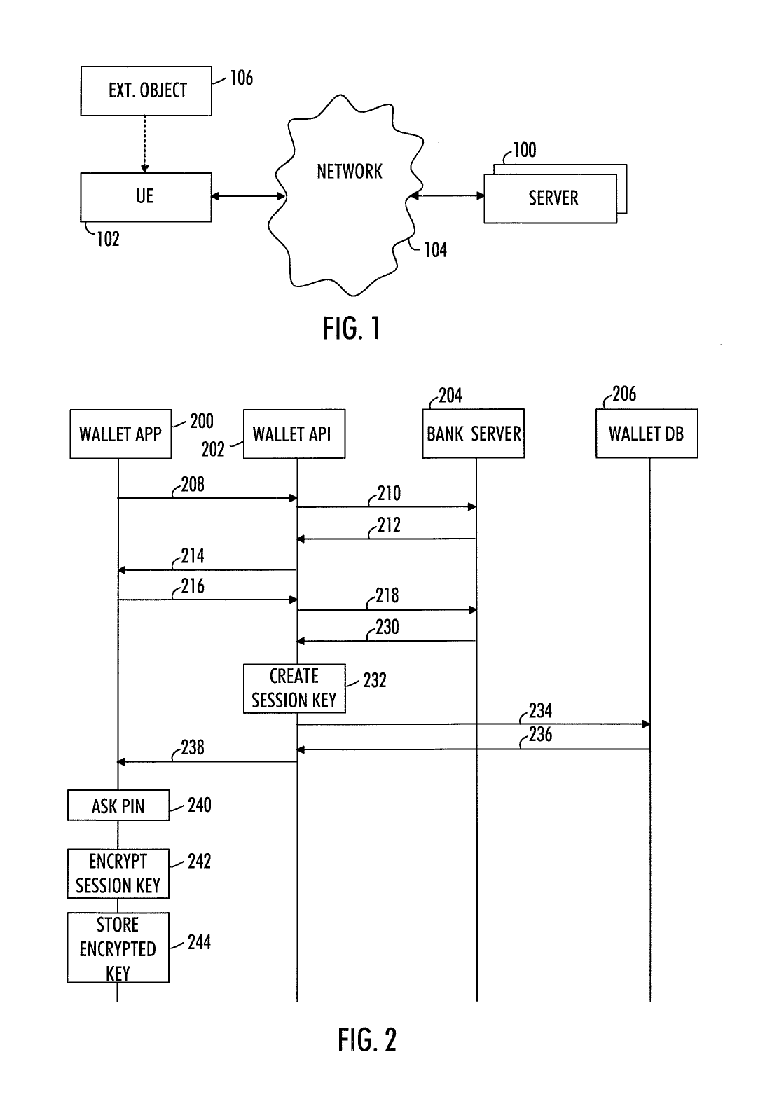

FIG. 1 illustrates an example of a general operating environment applicable to some embodiments of the invention. The environment comprises one or more network servers 100 running an authentication service and database operations, and user equipment 102 running software, and a communication network 104 connecting the network server 100 and the user equipment 102.

The communication network 104 may be a wired or wireless communication network or a combination of these. The network may include various wired/wireless standard, non-standard or proprietary communication networks such as a computer network, a private network, an IP-based network (TCP/IP=Transmission Control Protocol/Internet Protocol), the Internet, the telephone network including the public switched telephone network PSTN, any cellular network (such as a mobile phone network) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), a wireless local area network such as Wi-Fi or WLAN (Wireless Local Area Network) based on IEEE (Institute of Electrical and Electronics Engineers) 802.11 standard or its evolution versions or WiMAX (Worldwide Interoperability for Microwave Access, for example.

User equipment 102 refers to a computing device. Such computing devices include wireless mobile communication devices operating with or without a subscriber identification module (SIM), including, but not limited to, the following types of devices: a mobile phone, a smartphone, a personal digital assistant (PDA), a tablet computer, a laptop or table top computer.

The network server or servers 100 may be configured to offer the user equipment 102 authentication service and database operations. The server or servers 100 may be a personal computer or a set of computers or a computer network or any other kind of processing system comprising a at least one processor; and at least one memory including computer program code. The server is configured to be accessible by users through the communication network 104, for example. The server may comprise suitable interfaces and/or transceivers to contact the communication network.

The user equipment 102 may run software configured to authenticate the user of the user equipment by communicating with the server 100. Let us denote the software as electronic wallet application. FIG. 2 is a signalling chart of an example of possible authentication procedure. It is to be noted, however, that the embodiments of the invention are not limited to the presented authentication example. Also other kind of authentication procedures may be applied as one skilled in the art is well aware.

The example of FIG. 2 illustrates signalling between the wallet application 200, wallet application programming interface (API) 202, a server 204 configured to perform authentication and a database server 206. In an embodiment, the server 204 performs authentication of the user of the wallet application so that the wallet application may access the database server 206 in a secure manner. In an embodiment, the wallet application 200 and the wallet application programming interface (API) 202 are software run in user equipment.

In this example, the authentication procedure begins by the wallet application 200 sending 208 user id and password to wallet API 202. The wallet application may be configured to query the user id and password when the application is initialized or when the application is connecting to network in response to a user action.

The wallet API 202 forwards 210 the user id and password to the authentication server 204.

The authentication server 204 checks the user id and password and if correct responds with a message 212 comprising an acknowledgement and a key code challenge.

Many services utilized over communication networks require authentication. Typically, authentication is realised using a username and a password. In more sophisticated solutions, key codes or key numbers are used in addition to username and password authentication. The user may have a key code list comprising a set of challenges and corresponding responses as number pairs. A server requiring authentication submits the user a challenge, and the user is required to find the challenge from the key code list, find the response corresponding the challenge and submit the response. The server grants access if the submitted response was correct.

The wallet API receives the message 212 and forwards 214 it to the wallet application 200. The wallet application receives a response to the key code challenge from the user and sends 216 it to the wallet API. The wallet API transmits 218 the response the authentication server 204. The server authenticates the response and sends an acknowledgement 230 to the wallet API.

At this phase the two-level authentication has been performed. The first level comprises the user id and password and the second level the key code challenge/response.

In an embodiment, to finalize the process, the wallet API creates 232 a session id and a session key for the current on-going session. In an embodiment, the session key is a 256 bit random number. However, this is merely an example. The API transmits 234 a session id and session key to the database server 206.

The database server 206 acknowledges 236 the session data.

The wallet API transmits 238 the session id and session key to the wallet application.

In an embodiment, the wallet application is configured to query 240 the user a PIN (personal identification number). The PIN is utilised to encrypt 242 the session key.

The wallet application is then configured to store 244 the encrypted session key but delete the PIN and plain session key from memory.

The session id and key may be used in communication with the database server 206 to identify the user and user equipment. If a session is interrupted or timed out, a new session key may be created

Retailers or vendors may offer special benefits for loyal customers in form of a membership card or special discounts to all customers in form of electronic coupons or vouchers stored in mobile communication devices, for example. The wallet application 200 run in user equipment may be configured to store electronic membership cards or electronic coupons or vouchers. In the interest of security a method for authenticating the validity of the electronic cards, coupons or vouchers is needed.

In an embodiment, the database server 206 is configured to maintain a database comprising information on users and different electronic cards, coupons or vouchers associated with the users. The wallet application 200 run in user equipment may be configured to communicate with the database server when needed to show the retailer that the user has a valid card, coupon or voucher.

In an embodiment, the validation operation may be made easy and convenient for the user by utilising an identifier unique to the retailer at the retailer's premises. The identifier may be in a form easily readable by user equipment or mobile communication device. Examples of such identifiers are Quick Response QR codes or radio-frequency identification RFID tags.

Referring to FIG. 1, in an example embodiment, the identifier may be in a form of a Quick Response QR code being on an object 106 external to the user equipment. The object may be a paper sheet or adhesive label on which the QR code is printed. QR code is the trademark for a type of matrix barcode (or two-dimensional code) first designed for the automotive industry. The QR comprises black modules (square dots) arranged in a square pattern on a white background. The information encoded may be made up of four standardized modes of data (numeric, alphanumeric, byte/binary, Kanji), or through supported extensions, virtually any kind of data. The alphanumeric character codes of the QR code may include alphanumeric characters: numbers from “0” to “9”, alphabets from “A” to “Z” or “Ö” in Nordic languages, and “space”, “$”, “%, “*”, “+”, “−”, “.”, “/”, “\”, “|”, {”, “}”, “˜”, “*” and “:” as special characters, for example.

In another example embodiment, the identifier is in a form of radio-frequency identification RFID tag being on an object 106 external to the user equipment. The user equipment may comprise a near field communication NFC transceiver capable of reading RFID tags.

The identifier uniquely identifying the retailer may be located at the cashier desk at the retailer's premises, for example. Thus, a customer arriving at a retailer's premises may scan the identifier with the wallet application of the user equipment. The wallet application is configured to contact the database server and validate the coupons or benefits the user is entitled to. The wallet application may then display validation data on the screen of the user equipment.

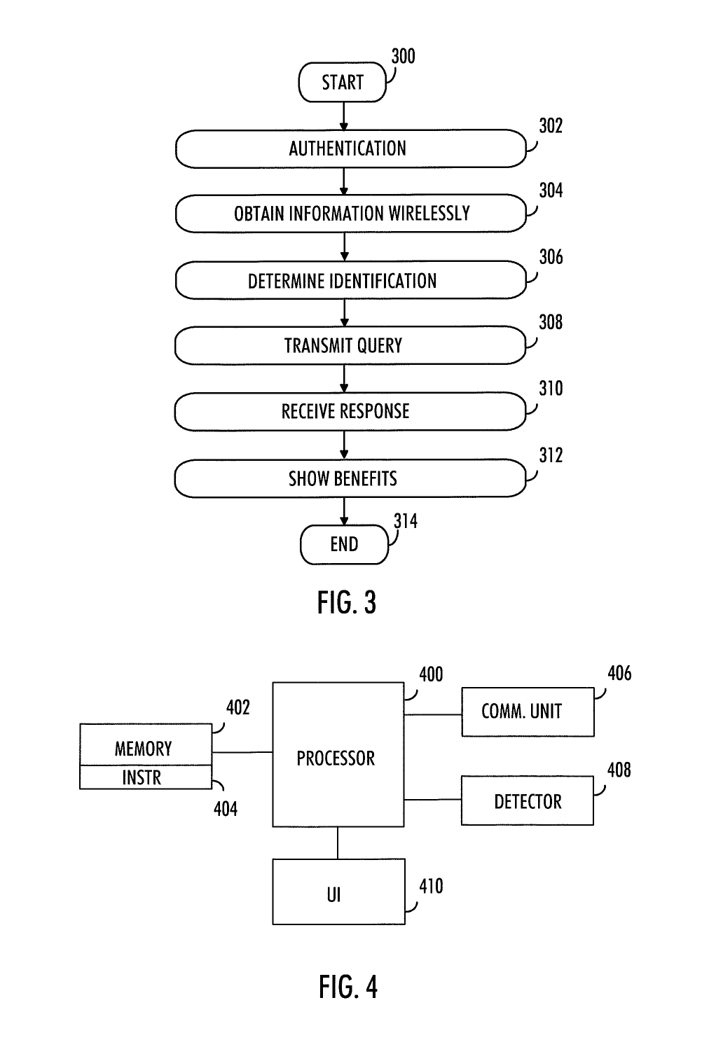

FIG. 3 is a flowchart illustrating an embodiment of the invention. The apparatus employing the embodiment may be user equipment 102 or a part of the user equipment, for example. The embodiment starts at step 300.

In step 302, the apparatus 102 is configured to execute wallet application and perform authentication. The authentication may be performed as described in connection with FIG. 2, for example.

In step 304, the apparatus is configured to control a detector to obtain in a wireless manner information on a retailer from an object 106 external to the apparatus.

In an embodiment, the apparatus comprises a camera. The user may point the camera to an adhesive label or paper sheet comprising retailer identification and the apparatus may be configured to automatically read the QR code printed on the adhesive or paper.

In an embodiment, the apparatus comprises an NFC transceiver and the apparatus is configured to read an RFID tag from an adhesive label or other object. These two cases are merely examples of possible realizations.

In step 306, the apparatus is configured to determine the identification of a retailer on the basis of the identifier.

For example, the apparatus may be configured to decode from the object external to the apparatus a universal resource locator (URL) comprising an Internet address. The URL may comprise a field identifying the retailer. For example, the URL may be of a form

http://wallet.com/intro/#####

where ##### is a series of digits unique to each retailer.

The apparatus may be configured to decode the series of digits from the URL.

The adhesive label, object or paper sheet comprising the identification and visible in the retailer's premises may act as an advertisement. For example, if the identification is read with a commercial QR reader application, the application would typically automatically open URL with a browser. The web page the URL is pointing to could promote the retailer and comprise a link to download the wallet application.

In step 308, the apparatus is configured to control the transmission of a query to the network server, the query comprising the identification of the retailer. In an embodiment, the query may comprise the identification of the user. The identification may be in the form of session id and session key. As the identification of the user may have been established during authentication procedure it may not be needed to transmit it again.

In step 310, the apparatus is configured to control the reception of a response from the server, the response comprising information on available retailer related benefits of the user.

If there are available benefits the apparatus is configured to control the user interface of the apparatus to communicate information on the validated benefits to the user in step 312. The user may then show the information at the cashier, for example. The apparatus may control the user interface to display an animation, for example. Alternatively, an image comprising electronic cards or vouchers may be shown on the display.

If there are no available benefits the apparatus may be configured initialise browser application and show a web page of the retailer and promote the user to store a bookmark or reference to the retailer within the walled application.

The process ends in step 314.

FIG. 4 illustrates an embodiment. The figure illustrates a simplified example of a device in which embodiments of the invention may be applied. In some embodiments, the device may be user equipment UE or a respective device communicating with a communications network. In some embodiments, the device may be a part of user equipment or a respective device. In general, device may be a computing device, including wireless mobile communication device operating with or without a subscriber identification module (SIM), including, but not limited to, the following types of devices: a mobile phone, a smartphone, a personal digital assistant (PDA), a tablet computer, a laptop or table top computer.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 400 configured to control at least part of the operation of the device.

The device may comprise a memory 402 for storing data. Furthermore the memory may store software 404 executable by the control circuitry 400. The memory may be integrated in the control circuitry.

The device may comprise a transceiver 406. The transceiver is operationally connected to the control circuitry 400. It may be connected to an antenna arrangement (not shown).

The software 404 may comprise a computer program comprising program code means adapted to cause the control circuitry 400 of the device to control a transceiver 406.

The device may further comprise user interface 410 operationally connected to the control circuitry 400. The user interface may comprise a display which may be touch sensitive, a keyboard or keypad (which may be implemented using a touch sensitive display), a microphone and a speaker, for example.

The control circuitry 400 is configured to execute one or more applications. The applications may be stored in the memory 402. The applications may generate data traffic with the system. The applications may require data from a server in the Internet or they may store data in the server. In general the traffic generated by applications may be periodic or continuous or something in between.

In an embodiment, the device comprises at least one detector unit 408. The detector unit may be a camera configured to take images, or an NFC transceiver configured to scan RFID tags. The software 404 may comprise a computer program comprising program code means adapted to cause the control circuitry 400 of the device to control the at least one detector unit 408.

Some of the above mentioned units might be accessories connectable to a device.

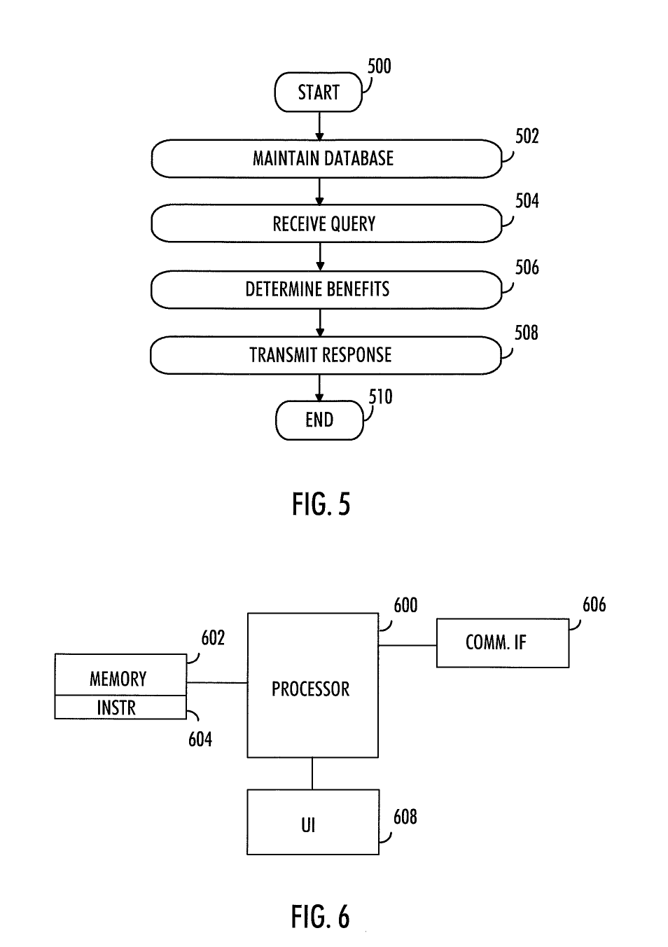

FIG. 5 is a flowchart illustrating an embodiment of the invention. The apparatus employing the embodiment may be a server 206 or a part of the server, for example. The embodiment starts at step 500.

In step 502, the apparatus 206 is configured to maintain a database or a connection to a database comprising information on users, benefits offered by retailers and which users are eligible for which benefit.

In step 504, the apparatus 206 receives a query regarding a user and a retailer.

In step 506, the apparatus 206 is configured to determine if the user is eligible for a benefit in the retailer. The apparatus may be configured to check from the database the benefits of a given user and determine if the retailer denoted in the query is found in the database.

In step 508, the apparatus 206 transmits a response on the basis of the determination.

The process ends in step 510.

FIG. 6 illustrates an embodiment. The figure illustrates a simplified example of a device in which embodiments of the invention may be applied. In some embodiments, the device may be a server 206 of FIG. 2 maintaining a database and communicating with user equipment UE or respective devices via a communications network. In some embodiments, the device may be a part of a server or a respective device. In general, device may be a computing device including, but not limited to, the following types of devices: a personal computer, a server computer.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 600 configured to control at least part of the operation of the device.

The device may comprise a memory or an interface 602 to a memory for storing data. Furthermore the memory may store software 604 executable by the control circuitry 600. The memory may be integrated in the control circuitry.

The device may comprise a communication interface 606. The communication interface is operationally connected to the control circuitry 600. The interface may provide the device a connection to a communication system. The connection may be wired or wireless. The interface may be a network interface card, a transceiver or any other kind of apparatus providing network connections.

The software 604 may comprise a computer program comprising program code means adapted to cause the control circuitry 600 of the device to control the communication interface a transceiver 406.

The device may further comprise user interface 608 operationally connected to the control circuitry 600. The user interface may comprise a display which may be touch sensitive, a keyboard or keypad (which may be implemented using a touch sensitive display), a microphone and a speaker, for example.

The control circuitry 600 is configured to execute one or more applications. The applications may be stored in the memory 602. The applications may generate data traffic with the system. The applications may require data from a server in the Internet or they may store data in the server. In general the traffic generated by applications may be periodic or continuous or something in between.

The applications may control the control circuitry 600 to maintain via the memory interface a connection to a database comprising information on users, benefits offered by retailers and which users are eligible for which benefit; receive via the communication interface a query regarding a user and a retailer; determine if the user is eligible for a benefit in the retailer and transmit via the communication interface a response on the basis of the determination.

Some of the above mentioned units might be accessories connectable to a device.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, or a circuitry that may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, the apparatus may also be implemented as an apparatus comprising means for receiving a challenge from a network server; means for controlling a detector to obtain wirelessly from an external object information on challenge/response pairs; means for determining a response to the challenge on the basis of the obtained information; and means for transmitting the response to the network server.

It will be obvious to a person skilled in the art that, as technology advances, the inventive concept can be implemented in various ways. The invention and its embodiments are not limited to the examples described above but may vary within the scope of the claim.

1-19. (canceled)

20. An apparatus, comprising:
at least one processor;
at least one memory including computer program code, and user interface;
the at least one memory and the computer program code configured to, with the at least one processor, cause the apparatus at least to perform:
control obtaining in a wireless manner information on a purchase independent identifier related to a retailer from an object external to the apparatus;
determine the identification of a retailer on the basis of the identifier;
control the transmission of a purchase independent query to the network server, the query comprising the identification of the retailer;
control the reception of a response from the server, the response comprising information on available retailer related benefits of the user;
and if there are available benefits, control the communication, utilizing the user interface, of the information on the benefits to the user.

21. The apparatus of claim 20, the at least one memory and the computer program code configured to, with the at least one processor, cause the apparatus at least to perform:
if there are no available benefits, control the communication, utilizing the user interface, of information related to the retailer.

22. The apparatus of claim 20, the at least one memory and the computer program code configured to, with the at least one processor, cause the apparatus at least to perform:
if there are available benefits, control the user interface to display an animation.

23. The apparatus of claim 20, the apparatus comprising a near field communication transceiver capable of obtaining information from a radio-frequency identification tag being on an object external to the apparatus.

24. The apparatus of claim 20, the apparatus comprising a camera; and the at least one memory and the computer program code being configured to, with the at least one processor, cause the apparatus further to perform:
control the camera to photograph a graphical code being on a surface of an object external to the apparatus; and
decode information from the graphical code.

25. The apparatus of claim 20, the at least one memory and the computer program code being configured to, with the at least one processor, cause the apparatus further to perform:
decode from the object external to the apparatus an universal resource locator comprising an Internet address.

26. The apparatus of claim 20, the at least one memory and the computer program code being configured to, with the at least one processor, cause the apparatus further to perform:
control the transmission of identification related to the user of the apparatus and the identification of the retailer in a single message.

27. The apparatus of claim 20, the at least one memory and the computer program code being configured to, with the at least one processor, cause the apparatus further to perform:
control the transmission of identification related to the user of the apparatus and the identification of the retailer in separate messages.

28. A server comprising:
a communication interface,
a memory interface, and
a processor,
wherein the processor is configured to cause the server at least to perform:
maintain via the memory interface a connection to a database comprising information on users, benefits offered by retailers and which users are eligible for which benefit;
receive via the communication interface a purchase independent query regarding a user and a retailer;
determine if the user is eligible for a benefit in the retailer;
transmit via the communication interface a response on the basis of the determination.

29. A method in an apparatus, comprising:
controlling a detector to obtain wirelessly from an object external to the apparatus information on a purchase independent identifier related to a retailer;
determining the identification of a retailer on the basis of the identifier;
controlling the transmission of a purchase independent query to the network server, the query comprising the identification of the retailer;
controlling the reception of a response from the server, the response comprising information on available retailer related benefits of the user;
and if there are available benefits, controlling the communication of the information on the benefits to the user.

30. The method of claim 29, further comprising:
controlling the communication, utilizing the user interface, of information related to the retailer if there are no available benefits.

31. The method of claim 29, further comprising:
controlling the user interface to display an animation if there are available benefits.

32. The method of claim 29, utilizing a near field communication transceiver to obtain information from a radio-frequency identification tag from an object external to the apparatus.

33. The method of claim 29, utilizing a camera to photograph a graphical code being on a surface of an object external to the apparatus; and
decode information from the graphical code.

34. The method of claim 29, further comprising:
decoding from the object external to the apparatus an universal resource locator comprising an Internet address.

35. The method of claim 29, further comprising:
controlling the transmission of identification related to the user of the apparatus and the identification of the retailer in a single message.

36. The method of claim 29, further comprising:
controlling the transmission of identification related to the user of the apparatus and the identification of the retailer in separate messages.

37. A method in an apparatus, comprising:
maintaining a database comprising information on users, benefits offered by retailers and which users are eligible for which benefit;
receiving a purchase independent query regarding a user and a retailer;
determining if the user is eligible for a benefit in the retailer;
transmitting a response on the basis of the determination.

38. A computer readable storage medium comprising one or more sequences of one or more instructions which, when executed by one or more processors of an apparatus, cause the apparatus to perform the steps of:
controlling a detector to obtain wirelessly from an object external to the apparatus information on a purchase independent identifier related to a retailer;
determining the identification of a retailer on the basis of the identifier;
controlling the transmission of a purchase independent query to the network server, the query comprising the identification of the retailer;
controlling the reception of a response from the server, the response comprising information on available retailer related benefits of the user;
and if there are available benefits, controlling the communication of the information on the benefits to the user.

39. A computer readable storage medium comprising one or more sequences of one or more instructions which, when executed by one or more processors of an apparatus, cause the apparatus to perform the steps of:
maintaining a database comprising information on users, benefits offered by retailers and which users are eligible for which benefit;
receiving a purchase independent query regarding a user and a retailer;
determining if the user is eligible for a benefit in the retailer;
transmitting a response on the basis of the determination.
